(19) United States
(12) Patent Application Publication
(10) Pub. No.: US 2025/0291208 A1
(43) Pub. Date: Sep. 18, 2025

(54) SMART EYEWEAR HAVING ACCESSIBLE TACTILE CONTROLS

(71) Applicant: Innovative Eyewear, Inc., Miami, FL (US)

(72) Inventors: Harrison Gross, North Miami, FL (US); Breno Cavazani Fuzette, Paulínia (BR); Clifford Gross, North Miami, FL (US)

(21) Appl. No.: 18/605,092

(22) Filed: Mar. 14, 2024

(51) Int. Cl. G02C 11/00; G02C 5/14

(52) U.S. Cl. CPC G02C 11/10; G02C 5/14

(57) ABSTRACT

Eyewear having speakers and a microphone, configured to pair or connect with mobile devices, and having a three-way tactile switch that can be operated by a user to perform various functions while a user of the eyewear is wearing gloves. The tactile switch may be configured to rotate about an axis and/or may be configured so that it can be pressed into the frame or temples of the eyewear. The tactile switch may be configured to have the paired or connected mobile device perform different functions depending on the direction, pressure and/or the duration of time the tactile switch is pressed.

### BACKGROUND OF THE INVENTION

Conventional glasses such as reading glasses and sunglasses are typically purchased to help a user see clearly, read, or protect the user's eyes from the sun. Protective eyewear, such as safety glasses are typically used to protect a user's eyes and/or part of a user's face from hazards. Protective eyewear are often used in industrial environments where protection of the user's eyes and hands may be required. Some protective eyewear, including safety glasses, are designed to meet OSHA and ANSI safety standards. For example, ANSI Z87.1-2015 includes criteria for using, testing, and maintaining eye protection to prevent or minimize injuries from eye hazards.

Protective eyewear may include a frame with one or more lenses, and may include temples that can extend from the frame, along the side of a user's head, to a location near or behind the user's ears. Some protective eyewear includes components that allow the eyewear to electronically connect to or pair with a mobile device or other electronic devices to allow users to, for example, play audio files. Such “smart” eyewear may include WiFi and/or Bluetooth® transceivers, or other similar components, such as the technology disclosed in U.S. Pat. No. 10,908,419, incorporated herein by reference, to connect to and/or communicate with a mobile electronic device and/or to control the components in the eyewear from a mobile electronic device.

Smart eyewear sometimes includes one or more touchpads on the temples to control their functions. For example, U.S. Pat. No. 8,203,502 discloses glasses having a touch-sensitive pad with a sensor configured to sense the position and movement of a user's finger relative to the touch-sensitive pad. Such touch-sensitive controls, however, cannot be operated while a user is wearing gloves which are not designed for use with a touch-sensitive pad. Accordingly, in settings where gloves are typically worn, for example, when work gloves are required to be worn for safety, a different interface is needed to allow a user to control the functions of the eyewear and any mobile devices paired or connected with the smart eyewear while wearing the gloves.

### SUMMARY OF THE INVENTION

It is an object of the present invention to provide eyewear having a tactile switch that can be operated by a user to perform certain functions. It is a further object of the present invention to provide eyewear having a three-way tactile switch that can be used by a user while they are wearing gloves, to perform three or more functions with hepatic feedback. The various functions a user may be able to perform using the tactile switch may include, for example, listening to music, adjusting sound volume, audio recording, accessing digital assistants, accessing generative AI applications, hearing aid, video playback, video recording, photography, fall detection, alertness monitoring, geo-location, pulse detection, wireless communication (e.g. cellular phone, Bluetooth, WiFi, etc.), virtual reality, augmented reality, eye tracking, pupil monitoring, scrolling a displayed image or text, and/or alarms. The eyewear may include its own components, circuitry and/or logic to perform one or more of these functions, or it may function as a Bluetooth headset incorporated in a pair of safety glasses, configured to pair with or connect to a mobile device such as a smart phone or smart watch. For example, the eyewear may include a one or more speakers, one or more removable or fixed storage media such as non-transitory memory on which an audio file can be stored and played by the speaker, one or more wireless transceivers or modules, a power source, one or more noise cancelling microphones, and one or more processors or controllers and one or more rechargeable batteries.

### BRIEF DESCRIPTION OF DRAWINGS

A further understanding of the invention can be obtained by reference to embodiments set forth in the illustrations of the accompanying drawings. Although the illustrated embodiments are merely exemplary of systems, methods, and apparatuses for carrying out the invention, both the organization and method of operation of the invention, in general, together with further objectives and advantages thereof, may be more easily understood by reference to the drawings and the following description. Like reference numbers generally refer to like features (e.g., functionally similar and/or structurally similar elements).

The drawings are not necessarily depicted to scale; in some instances, various aspects of the subject matter disclosed herein may be shown exaggerated or enlarged in the drawings to facilitate an understanding of different features. Also, the drawings are not intended to limit the scope of this invention, which is set forth with particularity in the claims as appended hereto or as subsequently amended, but merely to clarify and exemplify the invention.

FIG. 1 depicts exemplary eyewear in accordance with the present invention;

FIG. 2 depicts a rear bottom perspective view of the eyewear;

FIG. 3 depicts a side view of the eyewear;

FIGS. 4-6 depict a portion of exemplary eyewear having a nose pad in accordance with the present invention;

FIGS. 7 and 8 depict a portion of an exemplary temple of eyewear in accordance with the present invention;

FIG. 9 depicts a portion of exemplary eyewear in accordance with the present invention;

FIGS. 10-13 depict a portion of an exemplary temple in accordance with the present invention;

FIG. 14 depicts an exemplary tactile switch in accordance with the present invention;

FIG. 15 depicts an alternative exemplary tactile switch in accordance with the present invention.

### DETAILED DESCRIPTION OF THE INVENTION

The invention may be understood more readily by reference to the following detailed descriptions of embodiments of the invention. However, techniques, systems, and operating structures in accordance with the invention may be embodied in a wide variety of forms and modes, some of which may be quite different from those in the disclosed embodiments. Also, the features and elements disclosed herein may be combined to form various combinations without exclusivity, unless expressly stated otherwise. Consequently, the specific structural and functional details disclosed herein are merely representative. Yet, in that regard, they are deemed to afford the best embodiment for purposes of disclosure and to provide a basis for the claims herein, which define the scope of the invention. In addition, as used in the specification and the appended claims, the singular forms “a”, “an”, and “the” include plural referents unless the context clearly indicates otherwise.

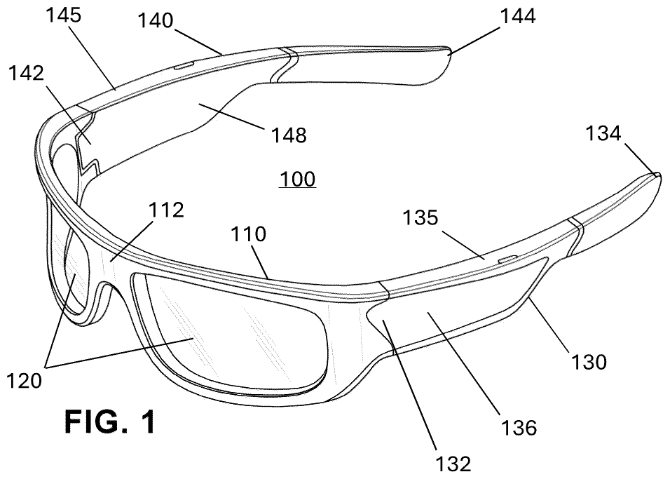

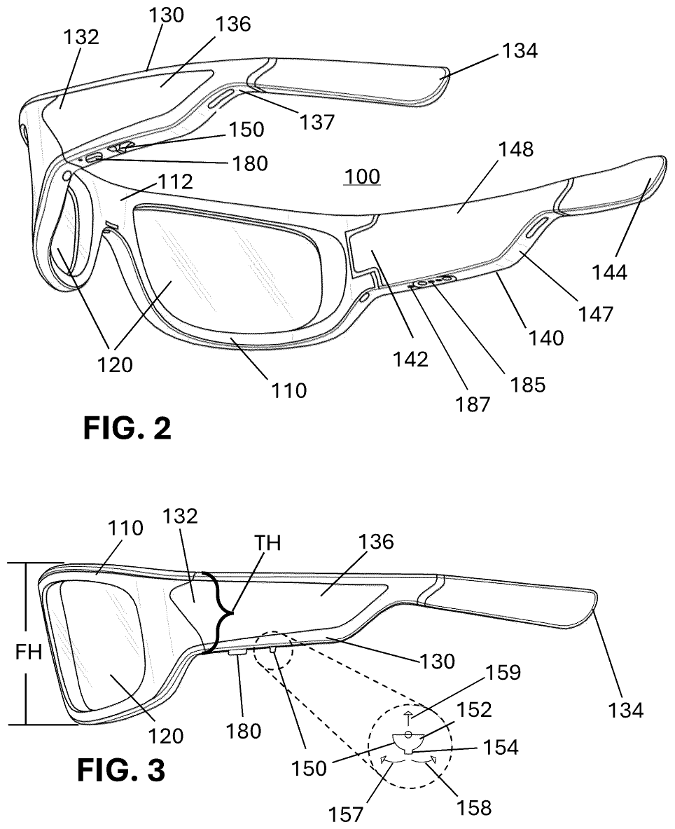

FIGS. 1-3 depict protective eyewear (100) having a frame (110) and lenses (120). Frame (110) may include a bridge (112) located between lenses (120). Frame (110) may be curved to provide greater protection for the user's eyes. For example, the plane of each lens (120) may be offset from the front of frame (110) by a curvature of between 20 degrees to 30 degrees, or any incremental degree of curvature therebetween, such as 27 degrees. Each lens may also meet ANSI standards Z87 or Z87+ for eye protection from impact.

Eyewear (100) further includes a first temple (130) and a second temple (140). First temple and second temple (130, 140) each extend from a first end (132, 142) to a second end (134, 144). First temple (130) and/or second temple (140) may have a top surface (135, 145), an outer side surface (136, 146), a bottom surface (137, 147), and an inner side surface (138, 148).

First end (132) of first temple (130) and first end (142) of second temple (140) may be hingeably connected to frame (110), allowing first temple and second temple (130, 140) to fold behind frame (110). Alternatively, first end (132) of first temple (130) and first end (142) of second temple (140) may be fixedly joined to frame (110). Alternatively, first end (132) of first temple (130) and first end (142) of second temple (140) may be connected to frame (110) using one or more of the teachings disclosed in U.S. Patent Publication No. 2021/0082011, titled, “Wireless Smartglasses with Quick Connect Front Frames,” and incorporated herein by reference.

Unless otherwise stated below, the teachings herein concerning first temple (130), including the structure, components, features, and functionality of first temple (130), may also be applied to second temple (140), including the structure, components, features, and functionality thereof. Accordingly, the discussions below concerning first temple (130) may be read as also describing second temple (140) and the corresponding aspects thereof.

Referring to FIG. 3, first end (132) of first temple (130) may have a height (TH) that is the same or approximately the same as height (FH) of frame (110). Height (TH) of first end (132) of first temple (130) may be selected to protect the user's eyes from hazards at the side of the user's head. For example, height (HT) of first end (132) of first temple (130) may be in the range of 20 mm to 30 mm, or any incremental height therebetween such as 22 mm.

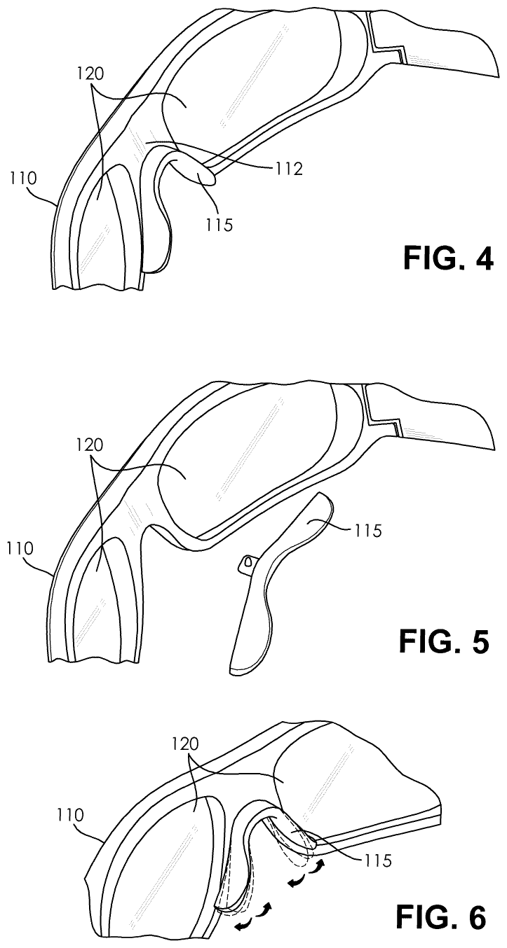

Referring to FIGS. 4-6, eyewear (100) may include nose pad (115) or two distinct nose pads (not shown) that may be, for example, attached to or located below bridge (112). Nose pad (115) is shown in FIGS. 4-6 as a single unitary component. Nose pad (115) may be fixedly attached to frame (110), or may be detachably joined to frame (110), such as by a magnetic connection, a snap fit, or any other suitably method. Nose pad (115) may be made from a flexible material, such as rubber, and may include one or more wires (not shown) extending within and partially or entirely along the length of nose pad (115). The flexible material (124) and/or the one or more wires may allow a user to change the shape of part of or all of nose pad (115). For example, nose pad (115) may be bent by a user into a new shape and may maintain the new shape after being bent. This flexibility may allow a user to better fit eyewear (100) to their face. As shown, for example, in FIG. 6, the shape of nose pad (115) may be adjusted (e.g. bent) by the user to ensure a more comfortable and/or a more secure fit.

In an alternative embodiment (not shown), eyewear may have a single lens that spans the width of frame (110), instead of two distinct lenses, and frame (110) may not include a bridge. In such an embodiment, one or more nose pads may be attached directly to the lens.

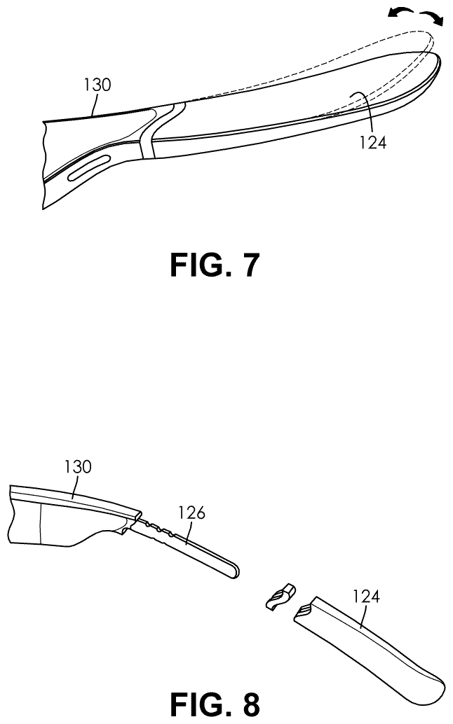

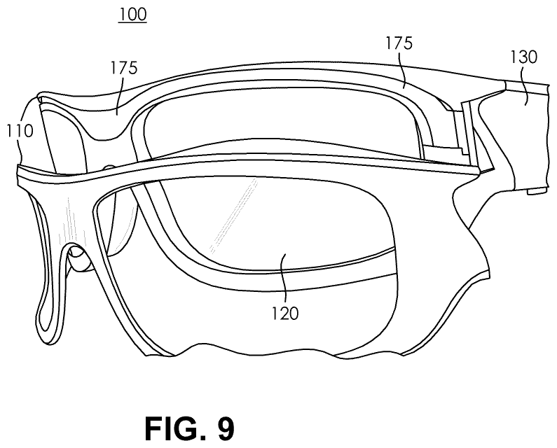

Referring to FIGS. 7 and 8, first temple (130) may be partly or entirely made from a flexible material (124), such as rubber, that allows part or all of first temple (130) to bend. As shown in FIG. 8 first temple (130) may additionally or alternatively include one or more longitudinal structures (126) extending within first temple (130) such as one or more posts or struts. The one or more longitudinal structures (126) may extend along the length of first temple (130) from first end (132) to second end (134), or may extend only partially along the length of first temple (130). The flexible material (124) and/or the one or more longitudinal structures (126) may allow a user to change the shape of part of or all of first temple (130). For example, flexible material (124) and one or more longitudinal structures (126) enclosed within flexible material (124), may be bent by a user into a new shape and may maintain the new shape after being bent. This flexibility may allow a user to better fit eyewear (100) to their face and head by bending second end (134) of first temple (130) toward or away from second end (144) of second temple (140), or toward or away from the user's head when the user is wearing eyewear (100).

Eyewear (100) may further include within frame (110) and/or temples (130, 140) electronic components to perform one or more functions, such as the components disclosed in U.S. Pat. Nos. 9,910,298 and 11,282,523. For example, eyewear (100) may include one or more microphones, one or more power sources, one or more speakers, a printed circuit board and/or processor, removable and/or fixed non-transitory memory, a connectivity module and hardware, one or more cameras, a wired connection port such as a USB port, an artificial intelligence interface, a wireless communications unit and hardware, and/or one or more projectors capable of projecting an image on the one or more lenses (120). The wireless communications unit and hardware may enable eyewear (100) to communicate over a wireless connection, such as a cellular connection, a Wi-Fi connection, or a Bluetooth connection and enable the eyewear (100) to pair or connect with one or more mobile devices, including smart phones and smart watches.

The one or more power sources may include, for example, one or more rechargeable batteries, one or more disposable batteries, one or more fuel cells, and/or one or more solar cells. Frame (110), first temple (130), and/or second temple (140) may have one or more charging ports (185) that can be used to charge the one or more batteries if eyewear (100) includes rechargeable batteries, or to power eyewear (100) from a battery or other power source that is not part of eyewear (100). Eyewear (100) may further include one or more charge indicator lights (187). The one or more charge indicator lights (187) may indicate by illuminating, illuminating multiple colors, and/or by flashing whether a charge is being supplied to eyewear (100) and/or one or more batteries therein. Additionally or alternatively, the one or more charge indicator lights (187) may indicate the charge status of one or more rechargeable batteries in eyewear (100).

To monitor the user and/or the user's environment, eyewear (100) or a mobile device paired or connected with eyewear (100) may further include one or more sensors, such as a pulse detector, a thermometer or thermopile, a carbon dioxide sensor, a carbon monoxide sensor, a smoke detector, an eye tracking sensor, a pupil monitoring sensor, a GPS sensor, a decibel level sensor, a blood oxygen sensor, and/or other biometric sensors.

Each of the electronic components may be electronically connected. To the extent eyewear (100) includes multiple instances of one or more components (e.g., multiple microphones or speakers) the components may be located in more than one location selected from the frame (110), first temple (130) and second temple (140). For example, to the extent eyewear (100) includes two speakers, one speaker may be located in first temple (130), and the other speaker may be located in second temple (140). A channel (175) hidden within frame (100) as shown in FIG. 9 may allow wires or other suitable electronic connection means to pass through channel (175) and connect components in first temple (130) with components in second temple (140), or to connect components in frame (110) with components in first temple (130) and/or second temple (140).

The components may allow the user of eyewear (100) to perform certain functions, such as listening to an audio file stored in the memory of the eyewear (100) or provided to the eyewear (100) from one or more mobile devices paired or connected with the eyewear (100) by playing the audio through the speakers in the eyewear (100). Additionally or alternatively, eyewear (100) may be configured to perform other functions, such as audio recording, hearing aid, video playback, video recording, photography, fall detection, alertness monitoring, geo-location, pulse detection, wireless communication (e.g. cellular phone, Bluetooth, WiFi, etc.), virtual reality, augmented reality, eye tracking, pupil monitoring, and/or alarms. Additionally or alternatively, one or more programs configured to launch one or more digital assistants may be stored in memory. The one or more processors and/or software stored in memory may be configured to launch the one or more digital assistants when requested by the user. Additionally or alternatively, the one or more processors and/or software stored in memory and/or one or more processors of a mobile device paired or connected with the eyewear (100) may be configured to enable the user of eyewear (100) to participate in group chat/communication by using, for example, the Vyrb Application as disclosed in U.S. Pat. No. 11,282,523, incorporated herein by reference.

Additionally or alternatively, components in eyewear (100) may allow eyewear (100) to communicate with and/or pair with one or more electronic devices, such as a cellular phone, tablet, smart watch, or computer. After connecting to an electronic device, the user of eyewear (100) may send a request, command, information, or other communication from eyewear (100) to the electronic device and cause the electronic device to perform one or more functions, such as placing a call, answering a call, requesting that a digital assistant provide information or perform a function, playing an audio file, vocalizing an SMS text message, scrolling a displayed image or text on a connected or paired mobile device, and/or orally dictating and sending an SMS text message. The electronic device may also send information or other communications to eyewear (100), such as weather information, calendar entries, or other notifications. When received by eyewear (100), information relating to the communication may be played by a speaker (or first converted to an audio file if not already in an audio format) and/or projected by a projector onto the one or more lenses (120).

As another example, eyewear (100) may be configured to launch a Generative AI application saved in memory of eyewear (100), saved on a device with which eyewear (100) is in communication and/or paired, and/or saved on a server, such as an internet or network server. Eyewear (100) may be configured to receive and/or record a verbal question or command from a user of eyewear (100), such as by one or more microphones located in frame (110) and/or temples (130, 140) of eyewear (100). Eyewear (100) may further be configured to execute a Generative AI application saved in memory of eyewear (100) in response to the received question or command, and output to the user a response generated by the Generative AI application using, for example, one or more speakers. Additionally or alternatively, eyewear (100) include one or more wireless transceivers or transmitters configured to transmit the verbal question or command, or information related to the verbal question or command, to a device with which eyewear (100) is in communication or paired, or to a server via, for example, the internet or a LAN, causing the mobile device or server, respectively to execute a Generative AI application. Eyewear (100) may further be configured to receive a response from the Generative AI application saved on a mobile device or server and output to the user a response generated by the Generative AI application using, for example, one or more speakers.

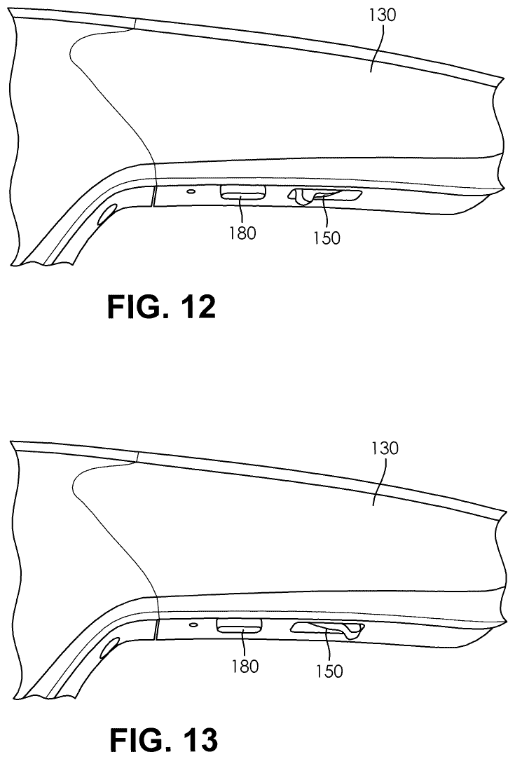

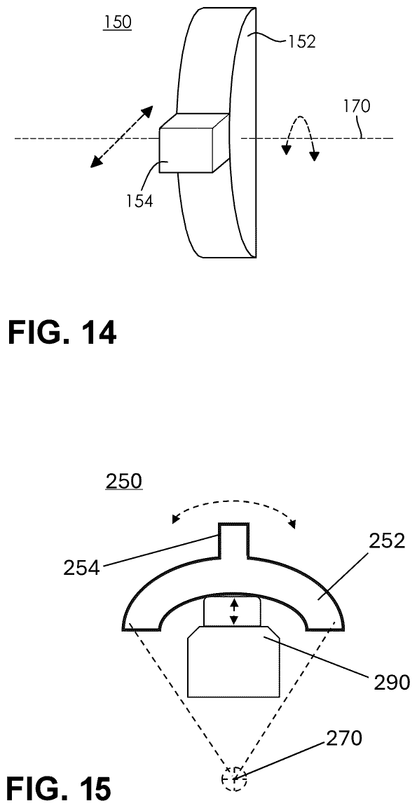

Referring to FIGS. 3 and 10-15, eyewear (100) may include one or more tactile switches (150, 250) and/or a button or switch (180) that may be used to turn on or off eyewear (100). Tactile switches (150, 250) may be in electronic communication with one or more processors in eyewear (100) and other components described above. A user of eyewear (100) may use a tactile switch (150, 250) to cause eyewear (100) to perform certain functions, such as launching programs or communicating with another electronic device. As shown in FIGS. 3 and 10-13, tactile switch (150, 250) may be on one of the first temple or second temples (130, 140). For example, tactile switch (150, 250) may be located on the underside (i.e., bottom surface (137)) of first temple (130). Alternatively, each tactile switch (150, 250) may be located at another location on first temple (130), such as at the top surface (135), outer side surface (136), or inner side surface (138) of first temple (130).

As shown in FIGS. 3, 14, and 15, tactile switch (150, 250) may have a base portion (152, 252) and one or more tabs (154, 254) that protrude from base portion (152, 252). Additionally or alternatively, base station may have one or more grooves and/or ridges (not shown). The one or more tabs (154, 254), grooves and/or ridges may help a user slide or otherwise move tactile switch (150, 250), particularly when the user is wearing gloves. One or more tabs (154, 254), grooves, and/or ridges on tactile switch (150, 250) may also serve to indicate to the user of eyewear (100) when the user's finger makes contact with tactile switch (150, 250).

Tactile switch (150, 250) may be capable of traversing and/or rotating in one or more

directions. For example, by applying pressure to tab (154, 254), tactile switch (150, 250) may be pressed toward and travel in the direction of first end (132) of first temple (130). As a further example, additionally or alternatively, by applying pressure to one or more tabs (154, 254) tactile switch (150, 250) may be pressed toward and travel in the direction (157) of second end (134) of first temple (130). In one exemplary embodiment, base portion (152, 252) may be configured to rotate about an axis (170, 270). Axis (170, 270) may be aligned perpendicular to or substantially perpendicular to the outer side surface (136) of the first temple (130). In such an exemplary embodiment, when tactile switch (150, 250) is pressed by the user in the direction (157) of first end (132) of first temple (130), tactile switch (150, 250) rotates about axis (170, 270) in the direction (157) of first end (132) of first temple (130), and when tactile switch (150, 250) is pressed in the direction (158) of second end (134) of first temple (130), tactile switch (150, 250) rotates about axis (170, 270) in the direction (158) of second end (134) of first temple (130).

Alternatively, base portion (152, 252) of tactile switch (150, 250) may be at least partially located in, and capable of sliding within, a straight or substantially straight channel (not shown) in first temple (130), so when tactile switch (150, 250) is pressed by the user in the direction of first end (132) of first temple (130), tactile switch (150, 250) travels linearly in the direction of first end (132) of first temple (130), and when tactile switch (150, 250) is pressed in the direction of second end (134) of first temple (130), tactile switch (150, 250) travels linearly in the direction of second end (134) of first temple (130).

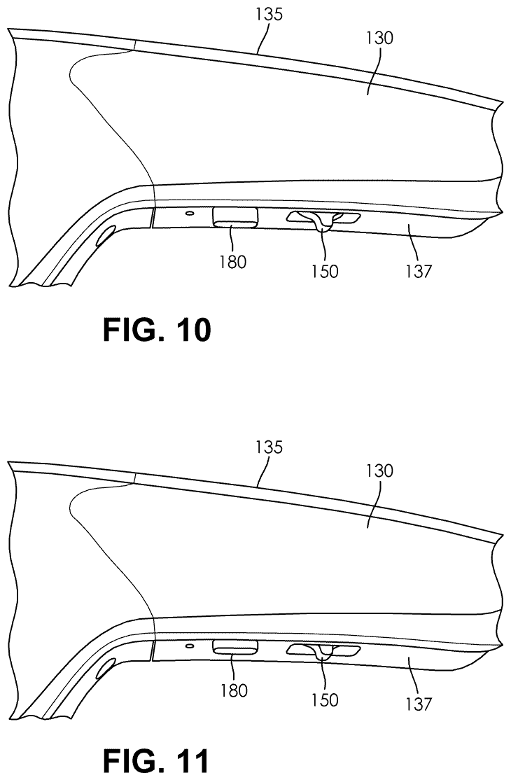

One or more springs or other suitable components (not shown) may be connected to tactile switch (150, 250) and first temple (130) or other components within first temple (130). Alternatively, as shown in FIG. 15, tactile switch (150, 250) may be attached to a mounting switch (290) within first temple (130) that allows tactile switch (150, 250) to rotate, traverse, and otherwise move as described herein. When tactile switch (150, 250) is in a “default” position (e.g. pointing downward), as shown in FIGS. 3 and 10, the one or more springs or other suitable components do not impose a force upon tactile switch (150, 250) sufficient to move tactile switch (150, 250). When a user slides or rotates tactile switch (150, 250) toward either first end (132) or second end (134) of first temple (130) and releases tactile switch (150, 250), the one or more springs or other suitable components may cause tactile switch (150, 250) to return to the default position.

When tactile switch (150, 250) is pressed in the direction of first end (132) or second end (134), different pressures by the user may cause tactile switch (150, 250) to travel different distances and activate different functions. For example, if the user is listening to a music audio file, applying pressure to tactile switch (150, 250) in the direction (157) of first end (132), up to a first predetermined threshold pressure, may cause tactile switch (150, 250) to rotate or travel a first distance or angle and to generate and send a first signal to the one or more processors to cause the music to be played at an accelerated pace (e.g., twice the default speed) or at a different (e.g. higher) volume level. Applying pressure to tactile switch (150, 250) in the direction (157) of first end (132), wherein the applied pressure exceeds the first predetermined threshold pressure, may cause tactile switch (150, 250) to travel or rotate a second distance or angle which is greater than the first distance or angle, and may trigger a different function, such as skipping to the next audio filed in a playlist.

Similarly, applying pressure to tactile switch (150, 250) in the opposite direction, toward second end (134) of first temple (130), up to a second predetermined threshold pressure, may cause tactile switch (150, 250) to travel or rotate a third distance or angle and generate and send a third signal to the one or more processors to, for example, cause the music to be played in reverse or at a different (e.g. lower) volume level. Applying pressure in the direction of second end (134) of first temple (130) in excess of the second predetermined threshold pressure, may cause tactile switch to travel or rotate a fourth distance or angle which is greater than the third distance or angle, and trigger yet a different function, such as skipping to the previous audio file in a playlist. The first predetermined threshold pressure and the second predetermined threshold pressure may be equal to each other. Also the first distance or rotation angle may equal the third distance or rotation angle, and the second distance or rotation angle may equal the fourth distance or rotation angle.

Alternatively, the user may activate various functions depending on the amount of time the user presses tactile switch (150, 250) in each direction (i.e., toward first end (132) or toward second end (134) of first temple (130)). For example, pushing or rotating tactile switch (150, 250) toward first end (132) of first temple (130) for a first predetermined period of time may cause a first signal to be generated and sent to the one or more processors, whereas pushing or rotating tactile switch (150, 250) toward first end (132) of first temple (130) for a period of time that is greater than the first predetermined period of time may cause a second signal to be generated and sent to the one or more processors. In that instance, the first signal may not be sent to the one or more processors unless the tactile switch returns or is returned to its default position before the first predetermined period of time is reached. Similarly, pushing or rotating tactile switch (150, 250) toward second end (134) of first temple (130) for up to or including a second predetermined period of time may cause a third signal to be generated and sent to the one or more processors, whereas pushing or rotating tactile switch (150, 250) toward second end (134) of first temple (130) for a period of time that is greater than the second predetermined period of time may cause a fourth signal to be generated and sent to the one or more processors.

Additionally or alternatively, tactile switch (150, 250) may be pressed into first temple (130) to activate or perform a function. For example, if tactile switch is located on the bottom surface (137) of first temple (130) as shown in FIGS. 3 and 10, applying pressure to tactile switch (150, 250) in the direction (159) of top surface (135), parallel or substantially parallel to outer side surface (136), may cause tactile switch (150, 250) to travel toward top surface (135). If tactile switch (150, 250) is located on top surface (135) of first temple (130), applying pressure to tactile switch (150, 250) in the direction of bottom surface (137) may cause tactile switch (150, 250) to travel parallel or substantially parallel to outer side surface (136), toward bottom surface (137). Likewise, if tactile switch (150, 250) is located on outer side surface (136) of first temple (130), apply pressure to tactile switch in the direction of inner side surface (138) may cause tactile switch (150, 250) to travel in the direction of inner side surface (138), and vice versa.

When tactile switch (150, 250) is pressed into first temple (130) as described above, different pressures by the user, or pressing tactile switch (150, 250) for a predetermined period of time, may activate different functions. For example, if the user is listening to a music audio file, applying pressure to tactile switch (150, 250) up to a third predetermined threshold pressure (which may be equivalent to first predetermined threshold pressure and/or second predetermined threshold pressure described above), may cause the music to stop. Pressing tactile switch (150, 250) in that manner again (up to a third predetermined threshold pressure) may cause the music file to continue playing. As another example, pressing tactile switch (150, 250) in that manner again (up to a third predetermined threshold pressure) may cause an incoming call to be answered, or may end an ongoing call.

If the user presses tactile switch (150, 250) into first temple (130) as described above, and if the applied pressure exceeds the third predetermined threshold pressure and/or if tactile switch (150, 250) is pressed for a predetermined period of time, a different function may be triggered. For example, a digital assistant may be launched. Alternatively, tactile switch (150, 250) may function as a power button so that applying pressure to tactile switch (150, 250) in excess of the third predetermined threshold pressure and/or for a predetermined period of time may cause eyewear (100) to turn on when it is off, or turn off when it is on.

One or more springs or other suitable components (not shown) may be connected to tactile switch (150, 250) and first temple (130) and configured so that when a user applies pressure to tactile switch (150, 250), causing tactile switch (150, 250) to traverse from a first “default” position to a second position located further within first temple (130), and the user then ceases applying pressure to tactile switch (150, 250), the one or more springs or other suitable components cause tactile switch (150, 250) to return to the first “default” position.

For the actions described above concerning tactile switch (150, 250), to the extent the function affected or initiated is being performed by eyewear (100), tactile switch may generate and send a signal when pressed to the one or more processors located in eyewear (100). For example, if eyewear (100) is playing an audio file, pressing tactile switch (150, 250) may cause a signal to be generated and sent to the one or more processors located in eyewear (100) to, for example, stop playing the audio file. To the extent a function affected or initiated is being performed by a mobile device paired or connected to eyewear (100) or a device with which eyewear (100) is in communication, tactile switch may send a signal to one or more processors located in eyewear (100), and the one or more processors may cause a signal to be transmitted to the electronic device to cause the desired function. For example, if a user receives a call on a mobile phone to which eyewear (100) is paired, pressing tactile switch (150, 250) may cause a signal to be transmitted to one or more processors in eyewear (100), and the one or more processors in turn may cause a transmitter in eyewear (100) to send a signal to the mobile phone or to another mobile device paired or connected to eyewear (100), instructing the mobile phone or the other mobile device to answer the call or perform one or more other functions. The mobile device can be programmed to have specific pressure thresholds when pressing tactile switch (150, 250) correspond to specific mobile device functions.

For the actions described above concerning tactile switch (150, 250), each time a function is affected or initiated, eyewear (100) may provide feedback to the user. For example, when a function is selected by a user of eyewear (100), eyewear (100) may make an audible sound, such as by emitting a beep or playing a tune or ringtone by one or more speakers. Additionally or alternatively, eyewear (100) may include a haptic engine or other means of generating haptic feedback (not shown). When a function is selected by a user of eyewear (100), eyewear (100) may provide a haptic response.

The actions described above concerning tactile switch (150, 250), may be customizable by a user of eyewear (100). For example, a user of eyewear (100) may launch an application on a mobile device with which eyewear (100) is in communication or paired. In the application, the user may select a function to be activated when tactile switch (150, 250) is used by the user, such as when the user presses tactile switch (150, 250) toward first end (132) of first temple (130), presses tactile switch (150, 250) toward second end (134) of first temple (130), or depresses tactile switch (150, 250) into first temple (130).

While the invention has been described with reference to the preferred embodiment and alternative embodiments, which embodiments have been set forth in considerable detail for the purposes of making a complete disclosure of the invention, such embodiments are merely exemplary and are not intended to be limiting or represent an exhaustive enumeration of all aspects of the invention. The scope of the invention, therefore, shall be defined solely by the following claims. Further, it will be apparent to those of skill in the art that numerous changes may be made in such details without departing from the spirit and the principles of the invention. It should be appreciated that the invention is capable of being embodied in other forms without departing from its essential characteristics.

What is claimed is:

1. Eyewear comprising:
a frame having one or more lenses;
a first temple extending from a first end to a second end, wherein the first end of the first temple is connected to the frame, and wherein said first temple has an outer side surface;
a second temple extending from a first end to a second end, wherein the first end of the second temple is connected to the frame;
a tactile switch connected to the first temple, wherein the tactile switch has an axis of rotation oriented perpendicular to the outer side surface of the first temple, wherein the tactile switch is configured to rotate about the axis of rotation and configured to traverse parallel to the outer side surface;
a processor in electronic communication with the tactile switch;
a wireless transceiver in electronic communication with the one or more processors; and
a power source in electronic communication with the one or more processors;
wherein at least a portion of the first temple is formed from a flexible material, and wherein the first temple comprises a strut extending into the portion of the first temple formed from the flexible material;
wherein the tactile switch is configured to generate a first signal and send the first signal to the processor;
wherein, in response to the first signal, the processor instructs the wireless transceiver to transmit a second signal to a mobile device.

2. The eyewear of claim 1, further comprising a nose pad connected to the frame.

3. The eyewear of claim 2, wherein the nose pad is at least partially formed from a flexible material.

4. The eyewear of claim 1, wherein the one or more lenses meet ANSI standards Z87 or Z87+ for eye protection.

5. The eyewear of claim 1, wherein the eyewear further comprises a microphone, the tactile switch is configured to execute a Generative AI application, and the microphone is configured to receive a verbal command.

6. The eyewear of claim 1, wherein rotation of the tactile switch about the axis of rotation by a predetermined first angle toward the first end of the first temple causes a first signal to be sent to the one or more processors, and rotation of the tactile switch about the axis of rotation by a predetermined second angle toward the first end of the first temple causes a second signal to be sent to the one or more processors.

7. The eyewear of claim 6, wherein rotation of the tactile switch about the axis of rotation by a predetermined third angle toward the second end of the first temple causes a third signal to be sent to the one or more processors, and wherein rotation of the tactile switch about the axis of rotation by a predetermined fourth angle toward the second end of the first temple causes a fourth signal to be sent to the one or more processors.

8. The eyewear of claim 1, wherein rotation of the tactile switch about the axis of rotation toward the first end of the first temple for a first predetermined period of time causes a first signal to be sent to the one or more processors, and rotation of the tactile switch about the axis of rotation toward the first end of the first temple for a second predetermined period of time causes a second signal to be sent to the one or more processors.

9. The eyewear of claim 8, wherein rotation of the tactile switch about the axis of rotation toward the second end of the first temple for a third predetermined period of time causes a third signal to be sent to the one or more processors, and rotation of the tactile switch about the axis of rotation toward the second end of the first temple for a fourth predetermined period of time causes a fourth signal to be sent to the one or more processors.

10. The eyewear of claim 1, wherein rotating the tactile switch may cause the one or more processors to enable a group communication amongst three or more persons, including the user of the eyewear.

11. Eyewear comprising:
a frame having one or more lenses;
a first temple extending from a first end to a second end, wherein the first end of the first temple is connected to the frame, and wherein said first temple has an outer side surface;
a second temple extending from a first end to a second end, wherein the first end of the second temple is connected to the frame;
a tactile switch connected to the first temple, wherein the tactile switch has an axis of rotation oriented perpendicular to the outer side surface of the first temple, wherein the tactile switch is configured to rotate about the axis of rotation and configured to traverse parallel to the outer side surface;
a processor in electronic communication with the tactile switch;
a wireless transceiver in electronic communication with the one or more processors; and
a power source in electronic communication with the one or more processors;
wherein the one or more lenses meet ANSI standards Z87 or Z87+ for eye protection;
wherein the tactile switch is configured to generate a first signal and send the first signal to the processor;
wherein, in response to the first signal, the processor instructs the wireless transceiver to transmit a second signal to a mobile device.

12. The eyewear of claim 11, wherein depressing the tactile switch perpendicular to the axis of rotation for a predetermined period of time causes power to be supplied from the power source to the one or more processors.

13. The eyewear of claim 11, further comprising a nose pad connected to the frame.

14. The eyewear of claim 13, wherein the nose pad is at least partially formed from a flexible material.

15. The eyewear of claim 11, wherein the eyewear further comprises a microphone, the tactile switch is configured to execute a Generative AI application, and the microphone is configured to receive a verbal command.

16. The eyewear of claim 11, wherein rotation of the tactile switch about the axis of rotation by a predetermined first angle toward the first end of the first temple causes a first signal to be sent to the one or more processors, and rotation of the tactile switch about the axis of rotation by a predetermined second angle toward the first end of the first temple causes a second signal to be sent to the one or more processors.

17. The eyewear of claim 16, wherein rotation of the tactile switch about the axis of rotation by a predetermined third angle toward the second end of the first temple causes a third signal to be sent to the one or more processors, and wherein rotation of the tactile switch about the axis of rotation by a predetermined fourth angle toward the second end of the first temple causes a fourth signal to be sent to the one or more processors.

18. The eyewear of claim 11, wherein rotation of the tactile switch about the axis of rotation toward the first end of the first temple for a first predetermined period of time causes a first signal to be sent to the one or more processors, and rotation of the tactile switch about the axis of rotation toward the first end of the first temple for a second predetermined period of time causes a second signal to be sent to the one or more processors.

19. The eyewear of claim 18, wherein rotation of the tactile switch about the axis of rotation toward the second end of the first temple for a third predetermined period of time causes a third signal to be sent to the one or more processors, and rotation of the tactile switch about the axis of rotation toward the second end of the first temple for a fourth predetermined period of time causes a fourth signal to be sent to the one or more processors.

20. The eyewear of claim 11, wherein rotating the tactile switch may cause the one or more processors to enable a group communication amongst three or more persons, including the user of the eyewear.
